(19) United States
(12) Patent Application Publication
(10) Pub. No.: US 2003/0210155 A1
(43) Pub. Date: Nov. 13, 2003

(54) Changing sequence of traffic light

(76) Inventor: Oleg Naljotov, Brooklyn, NY (US)

Correspondence Address: Oleg Naljotov, 1975 84str. Ap# B4, Brooklyn, NY, 11214, US

(21) Appl. No.: 09/844,746

(22) Filed: May 8, 2002

(51) Int. Cl. G08G 1/095

(52) U.S. Cl. 340/907

(57) ABSTRACT

The invention concerns to area, of traffic light and can be used on nation's roads witch have a traffic light for traffic control.

Proposal of my invention is to make the green signal of traffic light flash for 3 to 6 seconds before it changes to the yellow clearance, for the purpose of giving drivers an additional period of time to decide whether or not to stop when the yellow signal appears.

### THE DESCRIPTION OF THE INVENTION

The invention concerns to area, of traffic light.

The invention can be used at any road with have traffic light.

At this time sequence of traffic light using next order: green light, next is orange light, next is red light.

Invention required new order of traffic light: green light must be flashing for 3-6 seconds, before green light will be switched to orange light.

New order of traffic light gives to driver's additional time (3-6 second) to stop the car, before traffic light will be switched to red light.

What I claim as my invention is:

1. The invention concerns to area, of traffic light and can be used on nation's roads witch have a traffic light for traffic control.
Proposal of my invention is to make the green signal of traffic light flash for 3 to 6 seconds before it changes to the yellow clearance, for the purpose of giving drivers an additional period of time to decide whether or not to stop when the yellow signal appears.
